(19) United States
(12) Patent Application Publication
(10) Pub. No.: US 2005/0239399 A1
(43) Pub. Date: Oct. 27, 2005

(54) Mobile terminals and set top boxes including multiple satellite band service links, and related systems and methods

(76) Inventor: Peter D. Karabinis, Cary, NC (US)

Correspondence Address: MYERS BIGEL SIBLEY & SAJOVEC, PO BOX 37428, RALEIGH, NC, 27627, US

(21) Appl. No.: 11/096,862

(22) Filed: Apr. 1, 2005

Related U.S. Application Data
(60) Provisional application No. 60/564,177, filed on Apr. 21, 2004.

(51) Int. Cl. H04H 1/00

(52) U.S. Cl. 455/3.02

(57) ABSTRACT

A mobile terminal is configured to receive audio, video and/or data content from a first satellite over a first satellite frequency band and to communicate with a second satellite and/or an ancillary terrestrial network over a second satellite frequency band to control the receiving of the audio, video and/or data content from the first satellite over the first satellite frequency band. The mobile terminal may also communicate with a set top box when proximate thereto. Communications with the set top box may take place directly or via a relay. The set top box may also communicate with the first and/or second satellite using the relay. Related methods also are disclosed.

### CROSS-REFERENCE TO RELATED APPLICATION

This application claims the benefit of provisional Application No. 60/564,177, filed Apr. 21, 2004, entitled Mobile Terminals Including Multiple Satellite Band Service Links, and Related Systems and Methods, the disclosure of which is hereby incorporated herein by reference in its entirety as if set forth fully herein.

### FIELD OF THE INVENTION

This invention relates to wireless communications systems, methods and terminals, and more particularly to fixed and mobile wireless communications systems, methods and terminals.

### BACKGROUND OF THE INVENTION

Mobile terminals are widely used for communications, entertainment and/or data processing activities. As used herein, a mobile terminal includes cellular and/or satellite radioterminals with or without a multi-line display; Personal Communications System (PCS) terminals that may combine a radioterminal with data processing, facsimile and/or data communications capabilities; Personal Digital Assistants (PDA) that can include a radio frequency transceiver and/or a pager, Internet/Intranet access, Web browser, organizer, calendar and/or a global positioning system (GPS) receiver; and/or conventional laptop and/or palmtop computers or other mobile appliances, which include a radio frequency transceiver. As used herein, a mobile terminal may also include a satellite radio receiver, such as the widely used XM™ and/or Sirius™ satellite radio receivers. A mobile terminal may be handheld, portable and/or installed in a vehicle (aeronautical, maritime and/or land based). Conventionally, mobile terminals may be configured to receive large audio, video and/or data files from a satellite over a service link at relatively high bit or data rates.

### SUMMARY OF THE INVENTION

Mobile terminals according to some embodiments of the present invention include a mobile terminal transceiver system that is configured to receive audio, video and/or data content from a first satellite over a first satellite frequency band, and to communicate with a second satellite, a terrestrial network and/or an ancillary terrestrial network over a second satellite frequency band and/or a frequency band that is not authorized for satellite communications, to control the receiving of audio, video and/or data content from the first satellite over the first satellite frequency band. In some embodiments, the first satellite is a Direct Broadcast Satellite (DBS) and/or a satellite radio satellite, and the first satellite frequency band is a DBS and/or satellite radio frequency band. The second satellite is a Mobile Satellite System (MSS) and the second frequency band is an MSS frequency band and/or a frequency band that is not authorized for satellite communications.

In some embodiments, the mobile terminal transceiver system includes a mobile terminal receiver that is configured to receive the audio, video and/or data content from the first satellite over the first satellite frequency band, and a mobile terminal bidirectional transceiver that is configured to bidirectionally communicate with the second satellite, the terrestrial network and/or the ancillary terrestrial network over the second satellite frequency band and/or over the frequency band that is not authorized for satellite communications, to control the receiving of audio, video and/or data content from the first satellite over the first satellite frequency band. The mobile terminal receiver and the mobile terminal bidirectional transceiver may be at least partially integrated in the mobile terminal. In still other embodiments, the mobile terminal also includes a mobile terminal controller that is configured to request the audio, video and/or data content from a content provider over the second satellite frequency band and/or over the frequency band that is not authorized for satellite communications via the mobile terminal transceiver system, to obtain an authorization for the audio, video and/or data content from the content provider over the first and/or second satellite frequency band and/or over the frequency band that is not authorized for satellite communications via the mobile transceiver system, and to limit the audio, video and/or data content from being received and/or used at the mobile terminal absent the authorization.

In still other embodiments, the mobile terminal controller is further configured to preferentially request the audio, video and/or data content from the content provider via a set top box when the mobile terminal is proximate thereto, and to preferentially obtain the authorization for the audio, video and/or data content from the content provider via the set top box when the mobile terminal is proximate thereto. In yet other embodiments, the mobile terminal is also configured to preferentially receive the audio, video and/or data content from the content provider via a set top box when the mobile terminal is proximate thereto. In any of these embodiments, the mobile terminal may interact directly with the set top box when the mobile terminal is proximate thereto or may communicate with a relay device that itself communicates with the set top box when the mobile terminal is proximate to the relay device and/or the set top box. In still further embodiments, the mobile terminal is further configured to transmit remote control commands to the set top box, directly and/or via the relay device, when the mobile terminal is proximate to the set top box and/or the relay device.

Mobile terminals according to still other embodiments of the present invention include a mobile terminal transceiver system that is configured to communicate with a first satellite over a first satellite frequency band and to communicate with a second satellite, a terrestrial network and/or an ancillary terrestrial network over a second satellite frequency band and/or over a frequency band that is not authorized for satellite communications. In some embodiments, the first satellite is a DBS satellite and/or a satellite radio satellite, and the second satellite is an MSS satellite. In other embodiments, the mobile terminal transceiver system may also be configured to communicate with a set top box and/or a set top box relay device when the mobile terminal is proximate thereto.

Mobile terminals according to still other embodiments of the present invention include a mobile terminal transceiver system that is configured to communicate wirelessly using a terrestrial and/or satellite frequency band, and to communicate with a set top box when the mobile terminal is proximate thereto. In other embodiments, the mobile terminal transceiver system is further configured to communicate with a relay device that communicates with the set top box when the mobile terminal is proximate to the relay device.

Set top boxes according to various embodiments of the present invention include a set top box transceiver system that is configured to receive audio, video and/or data content from a first satellite over a first satellite frequency band and/or via a wired connection, and to communicate with a relay device that is external to the set top box that itself communicates with a second satellite, a terrestrial network and/or an ancillary terrestrial network over a second satellite frequency band and/or over a frequency band that is not authorized for satellite communications, to control the receiving of the audio, video and/or data content. The set top box may include a set top box receiver that is configured to receive the audio, video and/or data content from the first satellite over the first satellite frequency band, and/or via the wired connection, and a set top box bidirectional transceiver that is configured to bidirectionally communicate with the second satellite, the terrestrial network and/or the ancillary terrestrial network over the second satellite frequency band and/or over the frequency band that is not authorized for satellite communications via the relay device, to control the receiving of audio, video and/or data content from the first satellite over the first satellite frequency band and/or via the wired connection. A set top box controller may be configured to request the audio, video and/or data content from a content provider over the second satellite frequency band via the set top box transceiver system and the relay device, to obtain an authorization for the audio, video and/or data content from the content provider over the first and/or second satellite frequency band and/or over the frequency band that is not authorized for satellite communications via the set top box transceiver and/or the relay device, and to limit the audio, video and/or data content from being received and/or used at the set top box absent authorization. In some embodiments, the set top box controller is further configured to request audio, video and/or data content from the content provider in response to a request from a mobile terminal that is proximate to the relay device and/or the set top box, and to provide the audio, video and/or data content to the mobile terminal via the relay device and/or the set top box. In still other embodiments, the set top box controller is further configured to receive remote control commands for the set top box via the relay device. In some embodiments, the relay device is at least partially integrated into the set top box.

Set top box relay devices according to embodiments of the present invention include a set top box relay device transceiver system that is at least partially external to a set top box and is configured to communicate with the set top box over a wireless and/or wired connection, and to communicate with an MSS satellite, a terrestrial network and/or an ancillary terrestrial network over an MSS frequency band and/or over a frequency band that is not authorized for satellite communications. The set top box and/or the set top box relay device transceiver system may also be configured to wirelessly communicate with a mobile terminal that is proximate thereto and/or with a remote control unit that is proximate thereto.

Content providing systems according to various embodiments of the present invention can provide audio, video and/or data content to a mobile terminal. In some embodiments, these content providing systems include a first satellite that is configured to transmit the audio, video and/or data content to the mobile terminal over a first satellite frequency band, and a second satellite, terrestrial network and/or an ancillary terrestrial network that is/are configured to communicate with the mobile terminal over a second satellite frequency band and/or over a frequency band that is not authorized for satellite communications, to control the receiving of the audio, video and/or data content from the first satellite over the first satellite frequency band. The first satellite can be a DBS satellite and the second satellite can be an MSS satellite. The content providing system can include a content providing system controller that is configured to receive a request for the audio, video and/or data content from the mobile terminal over the second satellite frequency band and/or over the frequency band that is not authorized for satellite communications via the second satellite, the terrestrial network and/or the ancillary terrestrial network, and to provide an authorization for the audio, video and/or data content to the mobile terminal over the first and/or second satellite frequency band and/or over the frequency band that is not authorized for satellite communications via the second satellite, the terrestrial network and/or the ancillary terrestrial network. In other embodiments, the content providing system controller can refrain from providing the audio, video and/or data content to the mobile terminal over the first satellite frequency band via the first satellite if the request is unauthorized. In other embodiments, the content providing system controller can receive a request for the audio, video and/or data content from the mobile terminal via a set top box and/or a set top box relay device and can also provide the authorization to the mobile terminal via the set top box and/or the set top box relay device.

Mobile terminal communications systems according to other embodiments of the present invention include a first satellite that is configured to communicate with a mobile terminal over a first satellite frequency band and a second satellite, terrestrial network and/or an ancillary terrestrial network that are configured to communicate with the mobile terminal over a second satellite frequency band and/or over the frequency band that is not authorized for satellite communications. The first satellite frequency band may be a DBS and/or satellite radio frequency band, and the second satellite frequency band may be an MSS frequency band. The second satellite, terrestrial network and/or the ancillary terrestrial network may be configured to communicate with the mobile terminal via a set top box and/or a set top box relay device.

It will be understood that embodiments of the invention have been described above primarily with respect to devices, such as mobile terminals, set top boxes, set top box relay devices, content providing systems and/or mobile terminal communications systems. However, other embodiments of the present invention can provide analogous methods.

### BRIEF DESCRIPTION OF THE DRAWINGS

FIGS. 1-2 are block diagrams of systems, methods and devices according to various embodiments of the present invention.

FIG. 3 is a flowchart of operations that may be performed according to various embodiments of the present invention.

FIGS. 4-9 are block diagrams of systems, methods and devices according to other embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, like designations refer to like elements. It will be understood that when an element is referred to as being “connected”, “coupled” or “responsive” to another element, it can be directly connected, coupled or responsive to the other element or intervening elements may be present. Furthermore, “connected”, “coupled” or “responsive” as used herein may include wirelessly connected, coupled or responsive.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms first and second may be used herein to describe various elements, these elements should not be limited by these terms. These terms are only used to distinguish one element from another element. Thus, a first satellite below could be termed a second satellite, and similarly, a second satellite may be termed a first satellite without departing from the teachings of the present invention. As used herein, the term “and/or” includes any and all combinations of one or more of the associated listed items. The symbol “/” is also used as a shorthand notation for “and/or”.

Moreover, as used herein, “substantially the same” band(s) means that two or more bands being compared substantially overlap in frequency, but that there may be some areas of non-overlap, for example at a band end(s). “Substantially the same” air interface(s) means that two or more air interfaces being compared are similar but need not be identical. Some differences may exist in one air interface (i.e., a satellite air interface) relative to another (i.e., a terrestrial air interface) to account for and/or accommodate different characteristics that may exist between, for example, a terrestrial and satellite communications environments. For example, a different vocoder rate may be used for satellite communications compared to the vocoder rate that may be used for terrestrial communications (i.e., for terrestrial communications, voice may be compressed (“vocoded”) to approximately 9 to 13 kbps, whereas for satellite communications a vocoder rate of 2 to 4 kbps, for example, may be used); a different forward error correction coding, different interleaving depth, and/or different spread-spectrum codes may also be used, for example, for satellite communications compared to the coding, interleaving depth, and/or spread spectrum codes (i.e., Walsh codes, long codes, and/or frequency hopping codes) that may be used for terrestrial communications.

Some embodiments of the present invention provide mobile terminals that support multiple satellite band service links. A first service link may be provided that is configured to receive audio, video and/or data content from a first satellite using a first service link band. In some embodiments, this first service link may be a unidirectional service link operating at a relatively high bit rate. Mobile terminals according to embodiments of the invention are also configured to bidirectionally communicate over a second service link using a second satellite frequency band and/or a terrestrial frequency band. These bidirectional communications may take place with a second satellite over a second satellite frequency band, with a terrestrial network over a terrestrial frequency band and/or with an ancillary terrestrial network that uses at least some satellite band frequencies and/or other frequencies that are not authorized for satellite communications. The bidirectional service link may be employed to transmit authorization signals such as authentication signals, pay-per-view requests, purchase requests and/or other authorization signals from the mobile terminal to the system, and to receive acknowledgement signals, such as access codes, encryption keys and/or other acknowledgement signals from the system. Thus, in some embodiments of the present invention, a high bandwidth unidirectional service link may be provided for the mobile terminal to download audio, video and/or data content as large files, while a relatively lower bit rate link may be used for authorization and/or acknowledgement signals.

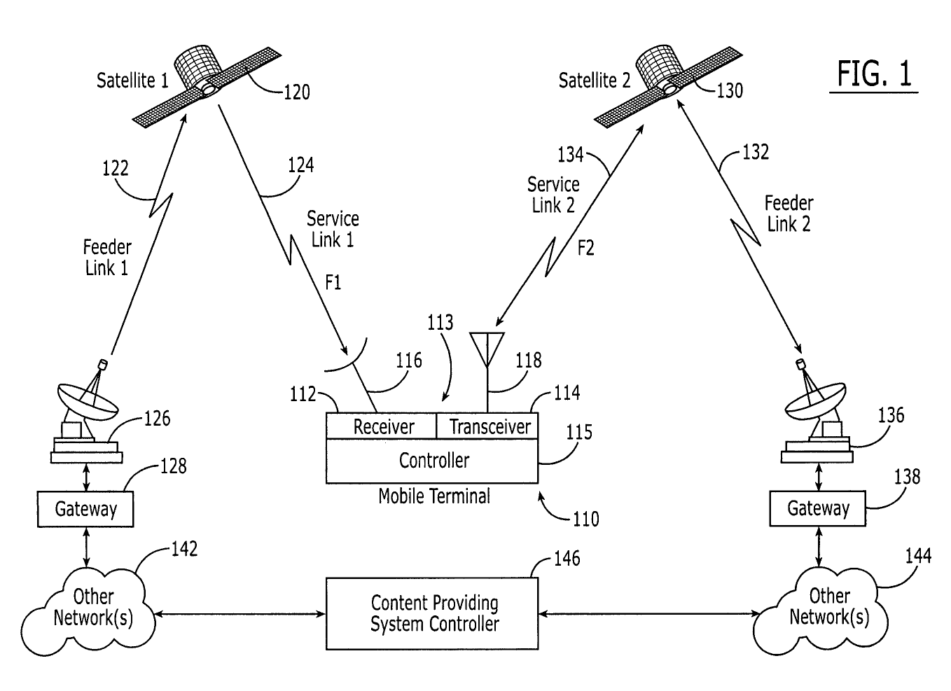

FIG. 1 is a block diagram of exemplary embodiments of the present invention. As shown in FIG. 1, a mobile terminal 110 is configured to communicate with a first satellite (Satellite 1) 120 and a second satellite (Satellite 2) 130. Communications with the first satellite 120 may occur over a first service link (Service Link 1) 124, which may be a unidirectional service link as shown in FIG. 1, and which may be configured to communicate with the mobile terminal 110 at relatively high bit rates. Audio, video and/or data content may be downloaded from the first satellite 120 to the mobile terminal 110 over the first service link 124 using a first satellite frequency band F1, which may be a Direct Broadcast Satellite (DBS), satellite radio and/or other satellite band(s) that is/are configured for high bit rate downloads of audio, video and/or data files. These audio, video and/or data files may be uplinked to the first satellite 120 via a satellite gateway 128, ground station 126 and first feeder link (Feeder Link 1) 122. The first service link 124 may be received at the mobile terminal 110 via an antenna 116 and a receiver 112 that are configured to receive the first satellite frequency band F1. In other embodiments, Service Link 1 and/or Feeder Link 1 may be bidirectional.

Still referring to FIG. 1, the mobile terminal 110 is also configured to bidirectionally communicate with the second satellite 130 over a second, bidirectional service link (Service Link 2) 134 using a second satellite frequency band, such as a satellite L Band, S Band or other band(s) that is/are used for Mobile Satellite System (MSS) communications, and/or for non-MSS communications, denoted by F2. A transceiver (transmitter/receiver) 114 and a transmit and receive antenna 118 are provided in the mobile terminal 110, to bidirectionally provide communications over the second service link 134. Communications are provided between the second satellite 130 and the ground via a second feeder link (Feeder Link 2) 132, a ground station 136 and a gateway 138. Communications from the gateway 128 and/or gateway 138 may be relayed to a system operator via other wired and/or wireless networks 142 and/or 144.

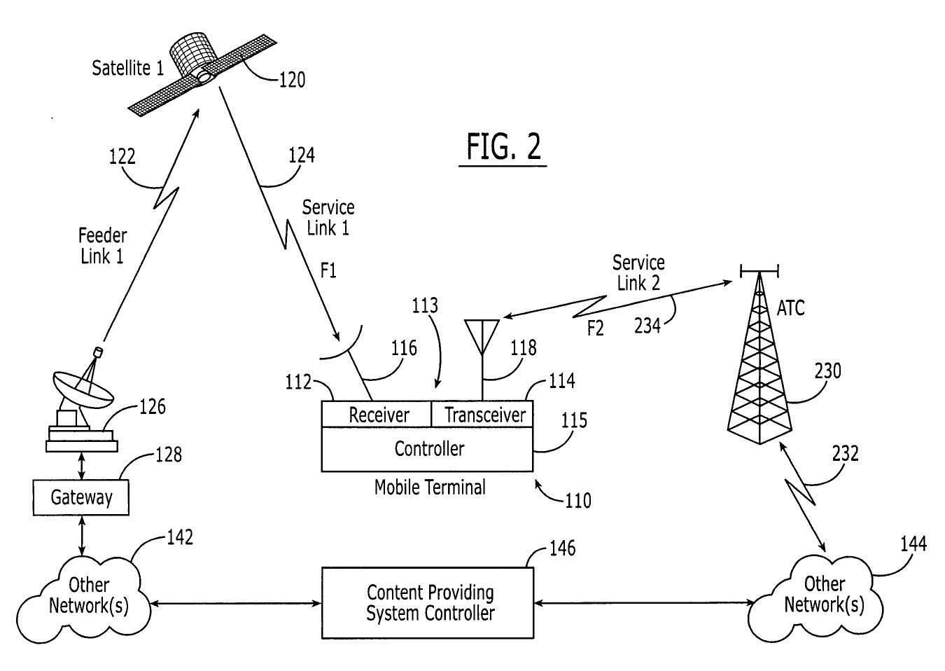

It will be understood by those having skill in the art that, although a separate receiver 112 and transceiver 114 are shown in the mobile terminal 110 of FIG. 1, some or all elements of the receiver 112 and the transceiver 114 may be integrated or combined using well known techniques. Thus, the receiver 112 and transceiver 114 collectively form a mobile terminal transceiver system 113 that is configured to receive audio, video and/or data content from a first satellite 120 over a first satellite frequency band F1, and to communicate with a second satellite 130 and/or an ancillary terrestrial network (shown in FIG. 2) over a second satellite frequency band F2, and/or to communicate with a terrestrial network over a terrestrial frequency band, such as, for example, a terrestrial cellular and/or PCS frequency band and/or an unlicensed frequency band (not shown), to control the receiving of the audio, video and/or data content from the first satellite over the first satellite frequency band. Similarly, although separate antennas 116 and 118 for the first and second service links 124, 134, respectively, are shown, these antennas may be combined, at least in part, in a broadband and/or multi-band antenna. Moreover, the mobile terminal 110 may include other processors, such as data processors and/or digital signal processors, a man-machine interface and other radio frequency components, as is well known to those having skill in the art. Thus, for example, the mobile terminal 110 may also include a mobile terminal controller 115 that is configured to request the audio, video and/or data content from a content provider system controller 146 over the second satellite frequency band F2 via the mobile terminal transceiver system 114, to obtain an authorization for the audio, video and/or data content from the content provider system controller 146 over the first and/or second satellite frequency band F1/F2 via the mobile terminal receiver/transceiver system 112/114, and to limit the audio, video and/or data content from being received and/or used at/by the mobile terminal 110 absent the authorization. As used herein, “limit” means the use is restricted in some way, absent the authorization. For example, all use may be prevented or only a limited use, such as sampling, may be allowed.

FIG. 2 is a block diagram of mobile terminals, methods and systems according to other embodiments of the present invention. In FIG. 2, the second service link 234 provides bidirectional communications with an ancillary terrestrial component 230 using satellite frequency band F2, which may be an L Band, S Band, any other Mobile and/or non-Mobile Satellite System band and/or other frequency band. The ancillary terrestrial component 230 may communicate via a terrestrial wired and/or wireless link 232 with other networks 144. The ancillary terrestrial component 230 may be a part of an ancillary terrestrial network that is configured to communicate with mobile terminals by terrestrially reusing at least part of a satellite frequency band.

Satellite radioterminal communications systems and methods that may employ terrestrial reuse of satellite frequencies are described in U.S. Pat. No. 6,684,057 to Karabinis, entitled Systems and Methods for Terrestrial Reuse of Cellular Satellite Frequency Spectrum; U.S. Pat. No. 6,856,787 to Karabinis, entitled Wireless Communications Systems and Methods Using Satellite-Linked Remote Terminal Interface Subsystems; U.S. Pat. No. 6,859,652 to Karabinis et al., entitled Integrated or Autonomous System and Method of Satellite-Terrestrial Frequency Reuse Using Signal Attenuation and/or Blockage, Dynamic Assignment of Frequencies and/or Hysteresis; and U.S. Pat. No. 6,785,543 to Karabinis, entitled Filters for Combined Radiotelephone/GPS Terminals; and Published U.S. Patent Application Nos. US 2003/0054761 to Karabinis, entitled Spatial Guardbands for Terrestrial Reuse of Satellite Frequencies; US 2003/0054814 to Karabinis et al., entitled Systems and Methods for Monitoring Terrestrially Reused Satellite Frequencies to Reduce Potential Interference; US 2003/0073436 to Karabinis et al., entitled Additional Systems and Methods for Monitoring Terrestrially Reused Satellite Frequencies to Reduce Potential Interference; US 2003/0054762 to Karabinis, entitled Multi-Band/Multi-Mode Satellite Radiotelephone Communications Systems and Methods; US 2003/0224785 to Karabinis, entitled Systems and Methods for Reducing Satellite Feeder Link Bandwidth/Carriers In Cellular Satellite Systems; US 2002/0041575 to Karabinis et al., entitled Coordinated Satellite-Terrestrial Frequency Reuse; US 2003/0068978 to Karabinis et al., entitled Space-Based Network Architectures for Satellite Radiotelephone Systems; US 2003/0153308 to Karabinis, entitled Staggered Sectorization for Terrestrial Reuse of Satellite Frequencies; and US 2003/0054815 to Karabinis, entitled Methods and Systems for Modifying Satellite Antenna Cell Patterns In Response to Terrestrial Reuse of Satellite Frequencies, all of which are assigned to the assignee of the present invention, the disclosures of all of which are hereby incorporated herein by reference in their entirety as if set forth fully herein.

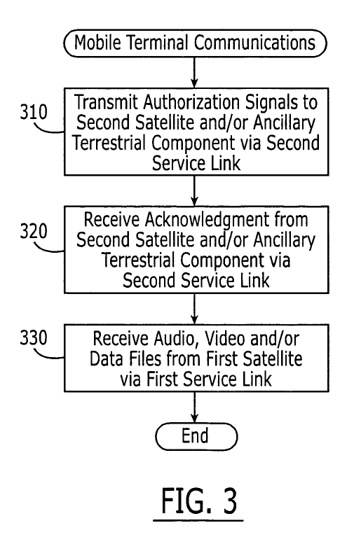

FIG. 3 is a flowchart of operations that may be performed for mobile terminal communications according to various embodiments of the present invention. These operations may be performed by the mobile terminal controller 115 and/or a content providing system controller 146. It will be understood by those having skill in the art that the content providing system controller 146 may be a standalone controller, as shown in FIGS. 1 and 2, or may be integrated and/or distributed at least partially in the other networks 142, 144, the gateways 128, 138, and/or other infrastructure components of the content providing system and/or the system comprising satellite 130 and/or ancillary terrestrial component 230.

Referring to FIG. 3, at Block 310, authorization/request signals are transmitted to the second satellite 130 and/or ancillary terrestrial component 230 via the second service link 134 and/or 234. It will be understood that the authorization signals may include any type of information which may be used by a subscriber to identify the subscriber and/or to make requests for service(s), such as request(s) to modify subscriber programming, request(s) for pay-per-view programming, request(s) for parental controls, request(s) to initiate, alter or maintain communications, etc. The authorization signals may also include information for authenticating the user's access to the audio, video and/or data files.

Still referring to FIG. 3, at Block 320, acknowledgement is received from the second/first satellite 130/120 and/or ancillary terrestrial component 230 via the second/first service link 134/124 and/or 234. The acknowledgement may include passwords and/or enablement signals that allow the mobile terminal 110 to receive the requested audio, video and/or data files. Finally, at Block 330, the audio, video and/or data files are received from the first satellite 120 via the first service link 124.

Accordingly, mobile terminals 110 of FIGS. 1 and/or 2 can receive information from a first satellite 120, typically at relatively high bit rates, over a first service link 124. The mobile terminal 110 is also operative to communicate bidirectionally with a second satellite 130 and/or an ancillary terrestrial component 230 (and/or a terrestrial network other than the terrestrial network comprising the ancillary terrestrial component; not shown), typically at relatively low bit rates, over a second service link 134 and/or 234. Embodiments of the present invention may be configured to transmit to the mobile terminal 110 specific information (audio, video and/or data content) via the first satellite 120, and the mobile terminal 110 may be configured to receive the specific information from the first satellite 120 in response to a specific request that is sent to an infrastructure element by the mobile terminal 110 via the second satellite 130 and/or the ancillary terrestrial component 230, and/or in response to an acknowledgement that is sent from the system to the mobile terminal 110 via the second/first satellite 130/120 and/or the ancillary terrestrial component 230 (and/or the terrestrial network other than the terrestrial network comprising the ancillary terrestrial component; not shown). A relatively high bit rate unidirectional service link 124 may thereby be used to transmit relatively large audio, video and/or data files to the mobile terminal 110, whereas a relatively low bit rate service link with a second satellite and/or an ancillary terrestrial component, may be used to transmit and receive requests, responses, confirmation, configuration, handshaking, housekeeping, acknowledgement, and/or other signals.

Accordingly, a mobile terminal controller 115 according to some embodiments of the invention may be configured to request the audio, video and/or data content from a content provider controller 146 over the second satellite frequency band F2 via the mobile transceiver system 114, to obtain an authorization for the audio, video and/or data content from the content provider controller 146 over the second/first satellite frequency band F2/F1 via the mobile terminal transceiver system/receiver 114/112, and to limit the audio, video and/or data content from being received and/or used at the mobile terminal 110 absent authorization. The content providing system controller 146 may also be configured to receive a request for the audio, video and/or data content from the mobile terminal 110 over the second satellite frequency band F2 via the second satellite 130 and/or the ancillary terrestrial component 230 (and/or via a terrestrial network other than the terrestrial network comprising the ancillary terrestrial component; not shown), and to provide an authorization for the audio, video and/or data content to the mobile terminal 110 over the second/first satellite frequency band F2/F1 via the second/first satellite 130/120 and/or the ancillary terrestrial component 230 (and/or the terrestrial network other than the terrestrial network comprising the ancillary terrestrial component; not shown). In other embodiments, the system controller 146 can refrain from providing the audio/video and/or data content to the mobile terminal 110 over the first satellite frequency band F1 via the first satellite 120 if the request is unauthorized.

It will also be understood that the operations of FIG. 3 may be performed out of the order shown in FIG. 3. For example, operations of Block 320 may be performed after those of Block 330, where the received files are stored, at least partially, but are not accessed until acknowledgement is received. Moreover, embodiments of FIGS. 1 and 2 may be combined to provide communications over both of the second satellite 130 and the ancillary terrestrial network 230 and/or the terrestrial network other than the terrestrial network comprising the ancillary terrestrial component 230; not shown.

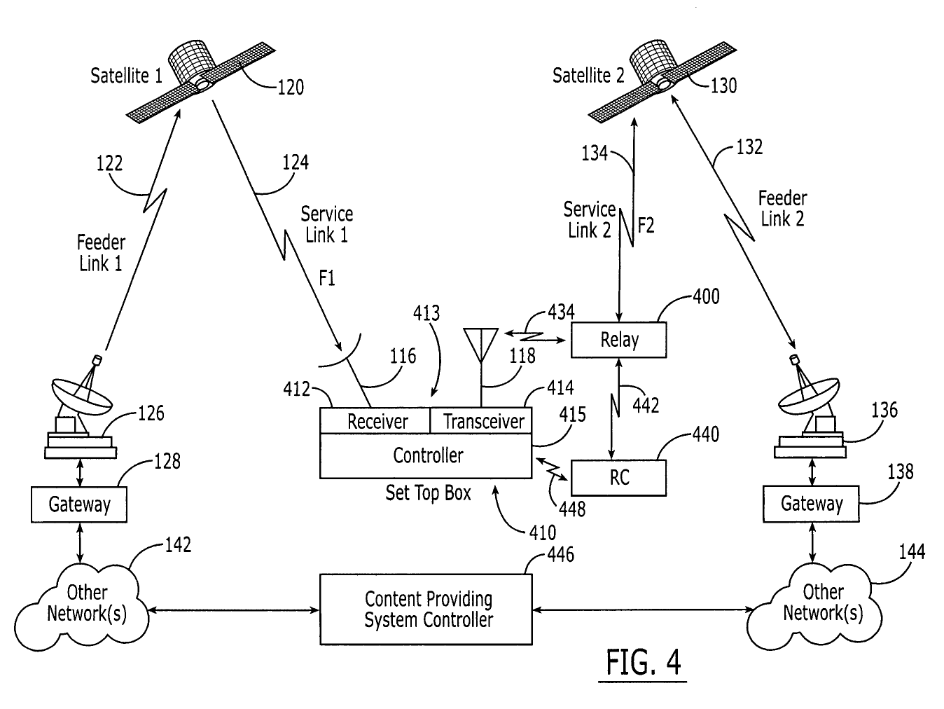

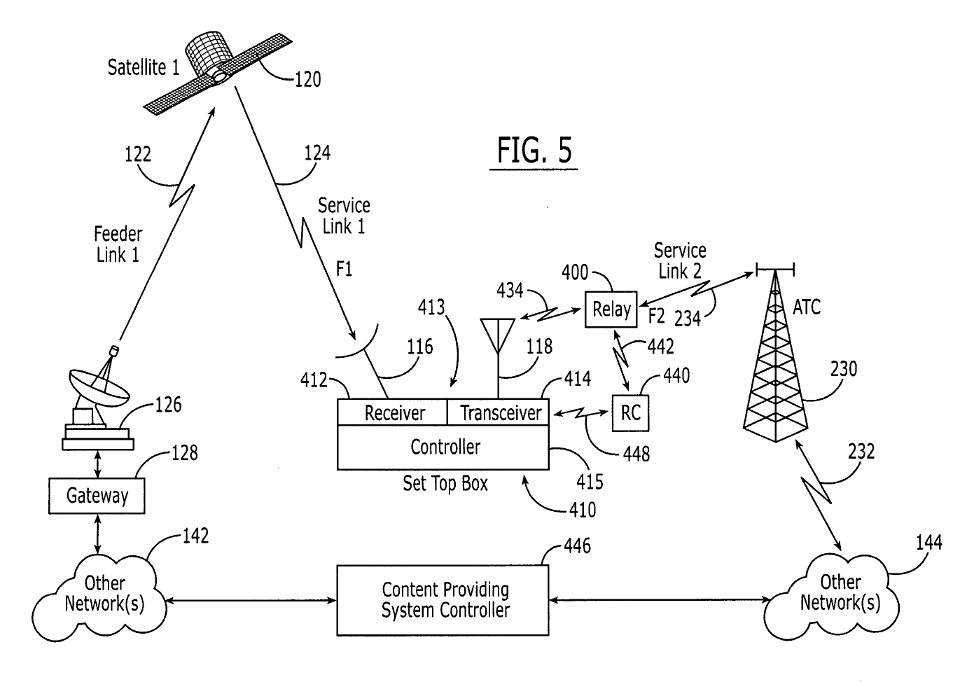

FIGS. 4 and 5 are block diagrams of yet other embodiments of the present invention. These embodiments may be used with a set top box 410, such as, for example, a television set top box, that is used to receive DBS and/or cable broadcasts in the home or other structures. As is well known to those having skill in the art, a set top box is an electronic device that is connected to one or more communications channel(s), such as, for example, a phone, ISDN, cable and/or satellite channel(s), and produces output on a television and/or computer screen. A set top box may be a standalone system and/or may be integrated into a television, digital video recorder, computer and/or other device. As shown in FIGS. 4 and 5, the set top box 410 includes a receiver 412 that is configured to receive audio, video and/or data content from a satellite link 124 and/or from a wired link (such as a cable television, telephone and/or data link not shown).

In embodiments of FIGS. 4 and 5, a relay device 400 is provided that acts as an intermediary device between the set top box 410 and the second satellite 130 (FIG. 4) and/or the ancillary terrestrial component 230 (FIG. 5). The relay 400 may communicate with the set top box 410 over a bidirectional link 434 that may be wireless (using terrestrial licensed and/or un-licensed frequencies and/or satellite frequencies and/or infrared transmission) and/or wired.

Some embodiments of FIGS. 4 and 5 may arise from a recognition that it may be difficult for a set top box 410 to communicate directly with the second satellite 130 and/or the ancillary terrestrial component 230. Accordingly, a relay 400 may be provided that can act as an intermediary to relay return link communications from the set top box 410 to the second satellite 130 and/or ancillary terrestrial component 230, and to also relay forward link communications from the second satellite 130 and/or the ancillary terrestrial component 230 to the set top box 410. The relay 400 may be placed adjacent a window or on a rooftop and, in some embodiments, may be integrated, at least in part, with an out-door unit structure that the set top box 410 uses, and located so as to increase or maximize the ability of the relay 400 to communicate with the second satellite 130 and/or the ancillary terrestrial component 230.

In some embodiments, the relay 400 can act as a non-regenerative repeater or as a regenerative repeater. As is well known to those having skill in the art, a non-regenerative repeater receives and retransmits a signal without demodulation and/or regeneration. In contrast, a regenerative repeater demodulates and decodes a received signal and then re-codes and re-modulates the demodulated and decoded signal for retransmission.

In some embodiments of the present invention, the relay 400 may operate in full duplex mode, with transmitting and receiving occurring simultaneously. However, other embodiments of the present invention may operate the relay 400 in half duplex mode based on a recognition that the communications between the set top box 410 and the second satellite 130 and/or the ancillary terrestrial component 230 may be in the form of short bursts of authorization signals and acknowledgement signals. Accordingly, potential interference and/or antenna isolation concerns may be reduced by allowing some embodiments of the relay 400 to operate in a half duplex mode. Thus, for example, the relay 400 may be operated to receive an authorization signal such as a request from the set top box 410 over the link 434. This signal may then be stored and the relay receiver associated with link 434 may be shut down for a predetermined interval of time. The transmitter in the relay 400 associated with link 134/234 may then be configured to transmit the received and stored signal, during the predetermined interval of time, to the second satellite 130 and/or the ancillary terrestrial component 230 over the return link portion of the second service link 134/234. Similarly, the relay 400 may be configured in a receive mode to receive an acknowledgement from the second satellite 130 and/or the ancillary terrestrial component 230 via the second service link 134/234. The receiver of the relay 400 associated with service link 134/234 may then be shut down for a predetermined interval of time and the transmitter of the relay 400 associated with link 434 may be activated to transmit, over the predetermined interval of time, the acknowledgement from the relay 400 to the set top box 410 over the link 434. By reducing or preventing simultaneous transmission and receiving by the relay 400, potential interference and/or antenna isolation concerns, in some embodiments, in the relay 400 may be reduced or eliminated.

Relays 400 of FIGS. 4 and 5 were described above as single function regenerative and/or non-regenerative repeaters. However, in other embodiments of the invention, the relay 400 may include other functions. For example, the relay 400 may be integrated into a set top box remote control unit, such as, for example, a television remote control unit, and can be used to relay user remote control commands to the second satellite 130, to the ancillary terrestrial component 230, to a terrestrial network (not shown) and/or to the set top box 410. In still other embodiments, the relay 400 may be configured to also accept remote control commands from a separate television or set top box remote control (RC) unit 440 via, for example, infrared links 442 (and/or other wireless and/or wired links), and to relay these commands to the set top box 410, the second satellite 130, the terrestrial network (which may also be connected to the content providing system controller 446; not shown) and/or the ancillary terrestrial component 230.

Operations of embodiments of FIGS. 4 and 5 may proceed as was described above in connection with FIG. 3, except that the transmission of Block 310 and receiving of Block 320 may occur via the relay 400 instead of directly to or from the second satellite 130 and/or ancillary terrestrial component 230. The remote control unit 440 may also communicate directly with the set top box 410 as is conventional using wired and/or wireless link 448.

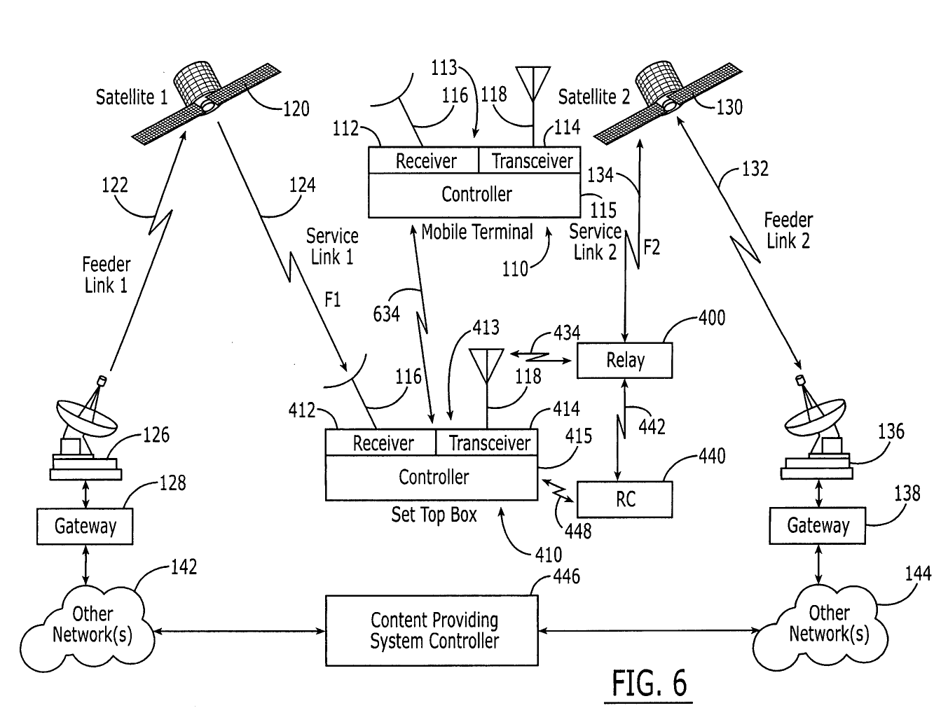

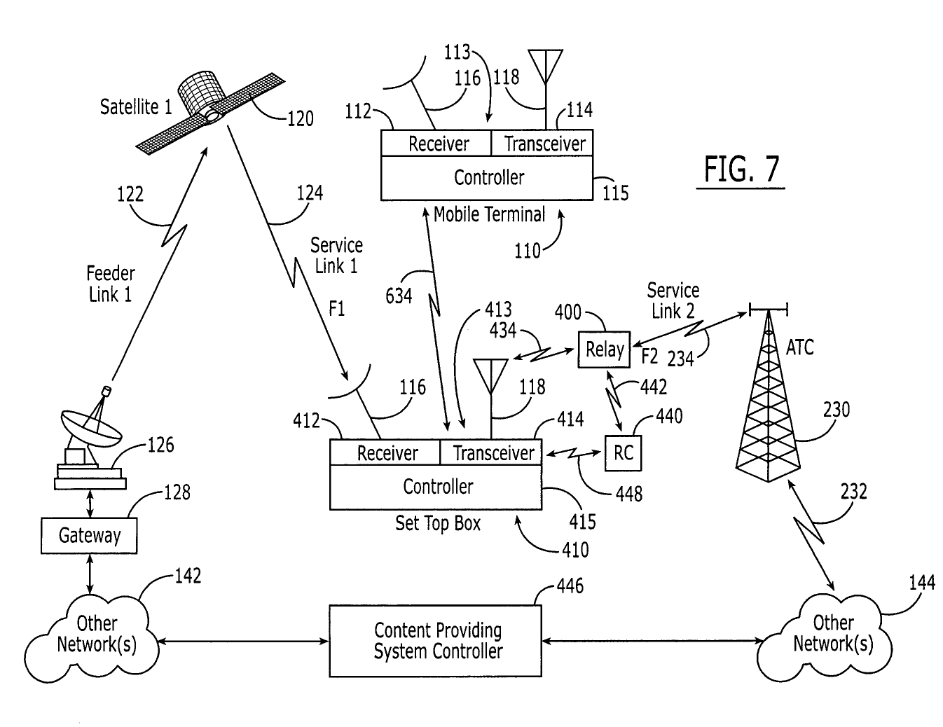

FIGS. 6-9 illustrate other embodiments of the invention. Embodiments of FIGS. 6-9 may operate in a similar manner as embodiments of FIGS. 1 and 2, when the mobile terminal 110 is remote from the set top box 410. However, as illustrated in FIGS. 6 and 7, when the mobile terminal 110 is proximate to the set top box 410, the mobile terminal 110 may preferentially communicate with first and/or second satellites 120 and/or 130 via one or more wireless links such as the wireless link 634 that is established between the mobile terminal 110 and the set top box 410, rather than communicating directly with the first and/or second satellites 120, 130 or the first satellite 120 and the ancillary terrestrial component 230. In some embodiments, the mobile terminal 110 may continue to communicate directly with the ancillary terrestrial component 230 and/or with a terrestrial network (other than the terrestrial network that includes the ancillary terrestrial component 230; not shown) even though the mobile terminal 110 is proximate to the set top box 410. In some embodiments, the link 634 may be a broadband wireless link that can accommodate transmission of the audio, video and/or data content and can also accommodate the authorization signals and/or acknowledgments that were described above. In other embodiments, the link 634 may include separate narrowband and/or wide band links. The link(s) 634 may use terrestrial and/or satellite (direct broadcast and/or mobile) frequencies and/or may use short range and/or ad hoc wireless network protocols and/or frequencies, such as WiFi, WiMAX, Bluetooth or ultra wide band protocols and/or frequencies.

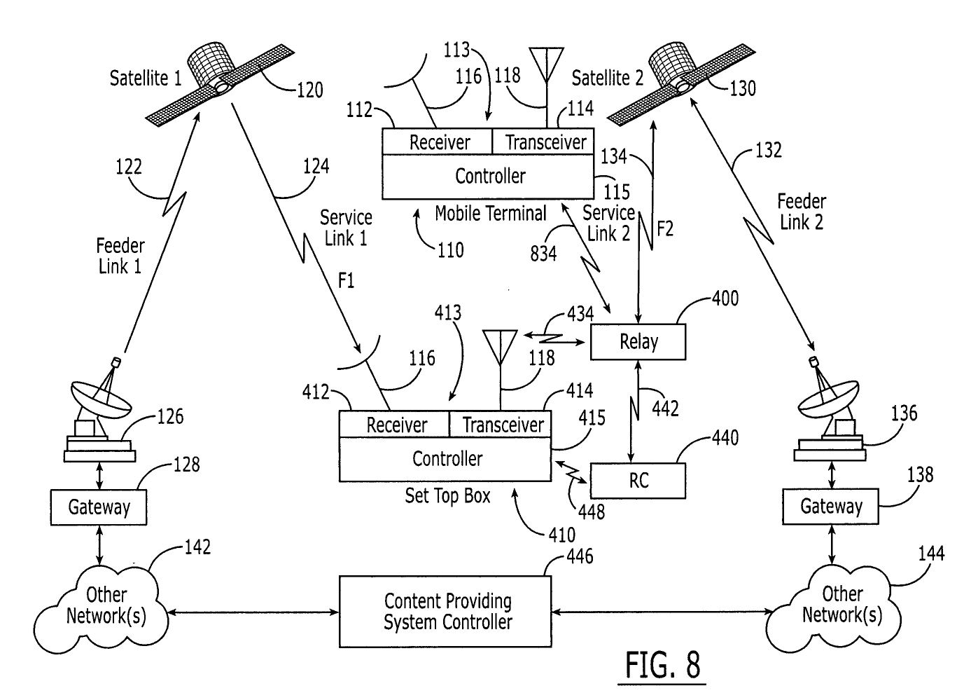

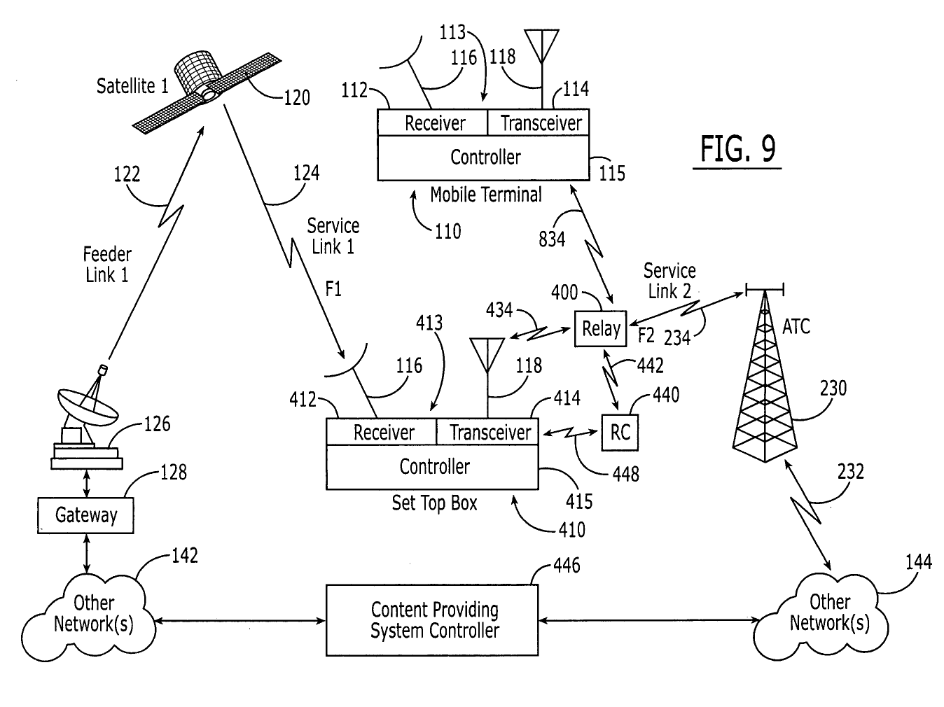

FIGS. 8 and 9 illustrate other embodiments of the present invention, wherein the mobile terminal 110 communicates with the set top box 410 via the relay 400 when proximate to the set top box 410 and/or relay 400 using one or more wireless links 834. Link(s) 834 may be configured as was described above in connection with link(s) 634. Combinations comprising link(s) 634 and 834 may also be provided in some embodiments.

Embodiments of the present invention that are described in FIGS. 6-9 may arise from a recognition that satellite frequency communications may be degraded when a mobile terminal 110 enters a home or other structure due to signal blockage and/or attenuation of satellite signal(s). However, when in the home or other structure, the mobile terminal 110 can wirelessly communicate with the set top box 410, directly and/or via the relay device 400. Thus, a seamless handoff for content delivery may be provided in some embodiments of the present invention, between direct communications with the first and/or second satellites (FIGS. 1-2) and communication with the first and second satellites via a set top box 410 and/or relay 400 (FIGS. 6-9). Connections are, therefore, preferentially established with the set top box 410 and/or relay 400 when the mobile terminal 110 is proximate to the set top box and/or relay, according to some embodiments of the present invention.

In some embodiments, a mobile terminal 110, a set top box 410 and/or a relay 400 may each include an identifier that establishes an identity, subscription, family and/or group of the mobile terminal 110, the set top box 410 and/or the relay 400. This identifier may be communicated between the set top box, relay and/or mobile terminal when the mobile terminal is proximate to the set top box and/or relay. The communicated identifier information (or at least a measure thereof) may further be communicated by the receiving device (the set top box, the relay or the mobile terminal) to a system element, such as, for example, to the content providing system controller 446, and/or other system element. A linkage, hand-shake, configuration and/or presence between the three (or more) devices (a set top box, a relay and/or one or more mobile terminals) may thus be established. In such embodiments, the mobile terminal 110 may be configured to receive service only from a set top box 410 and/or relay 400 that include(s) an identifier that matches and/or correlates in a predetermined way with the identifier of the mobile terminal when the mobile terminal is proximate to the set top box and/or relay. The set top box and/or relay may also be configured to provide service only to a mobile terminal (or mobile terminals) that include(s) an identifier that matches and/or correlates in a predetermined way with the identifier of the set top box and/or relay when the mobile terminal (or terminals) is/are proximate to the set top box and/or relay and request(s) service from the set top box and/or relay.

In other embodiments, a mobile terminal 110, a set top box 410 and/or a relay 400 may each include an identifier that establishes an identity, subscription, family and/or group of the mobile terminal 110, the set top box 410 and/or the relay 400. This identifier may be communicated between the set top box, relay and/or a mobile terminal when the mobile terminal is proximate to the set top box and/or relay and the mobile terminal, set top box and/or relay may communicate at least a portion (and/or a measure) of the received identifier information to a system element, such as, for example, the content providing system controller 446, and/or other system element. A linkage, hand-shake, configuration and/or presence between the three (or more) devices (a set top box, a relay and/or one or more mobile terminals) may thus be established. In such embodiments, the mobile terminal 110 may be configured to receive service from any set top box 410 and/or relay 400 that has received a valid identifier of the mobile terminal when the mobile terminal is proximate to the set top box and/or relay. The set top box and/or relay may also be configured to provide service to any mobile terminal (or mobile terminals) that transmit(s) a valid identifier to the set top box and/or relay that matches and/or correlates in a predetermined way with, for example, a data base of system identifiers when the mobile terminal (or terminals) is/are proximate to the set top box and/or relay and request(s) service from the set top box and/or relay.

Thus, as shown in FIGS. 6-9, the mobile terminal transceiver system 414 may be configured to communicate with a set top box 410 when the mobile terminal 110 is proximate thereto, either directly or via a relay device 440. The set top box 410 may also be configured to wirelessly communicate with a mobile terminal 110 that is proximate thereto. The set top box relay device 400 also may be configured to wirelessly communicate with a mobile terminal 110 that is proximate thereto. The content providing system 446 may be further configured to communicate with a mobile terminal 110 via a set top box 410 that is proximate to the mobile terminal 110.

In some embodiments of the present invention (FIGS. 6 and 7), the mobile terminal controller 115 is further configured to preferentially request the audio, video and/or data content from the content provider 446 via a set top box 410 when the mobile terminal 110 is proximate thereto, and to preferentially obtain the authorization for the audio, video and/or data content from the content provider 446 via the set top box 410 when the mobile terminal 110 is proximate thereto. The mobile terminal controller 115 may also be configured to preferentially receive the audio, video and/or data content from the content provider 446 via the set top box 410 when the mobile terminal 110 is proximate thereto. In still other embodiments (FIGS. 8 and 9), these preferential requests and receipts may be performed via a relay device 400 that communicates with the set top box 410 when the mobile terminal 110 is proximate to the relay device 400. In further embodiments, the mobile terminal controller 115 is further configured to preferentially request the audio, video and/or data content from the content provider 446 via the satellite 130, a terrestrial network and/or ancillary terrestrial component 230 when the mobile terminal 110 is proximate to the set top box 410 and/or relay 400, and to preferentially obtain the authorization for the audio, video and/or data content from the content provider 446 via the satellite 130, a terrestrial network and/or ancillary terrestrial component 230 when the mobile terminal 110 is proximate to the set top box 410 and/or relay 400. The mobile terminal controller 115 may also be configured to preferentially receive the audio, video and/or data content from the content provider 446 via the set top box 410 when the mobile terminal 110 is proximate thereto. In still other embodiments, the preferential receipt of the audio, video and/or data content from the content provider 446 may be performed via a relay device 400 that communicates with the set top box 410 when the mobile terminal 110 is proximate to the relay device 400.

In the drawings and specification, there have been disclosed embodiments of the invention and, although specific terms are employed, they are used in a generic and descriptive sense only and not for purposes of limitation, the scope of the invention being set forth in the following claims.

1. A mobile terminal comprising:
a mobile terminal transceiver system that is configured to receive audio, video and/or data content from a first satellite over a first satellite frequency band and to communicate with a second satellite and/or an ancillary terrestrial network over a second satellite frequency band to control the receiving of the audio, video and/or data content from the first satellite over the first satellite frequency band.

2. A mobile terminal according to claim 1 wherein the first satellite is a Direct Broadcast Satellite (DBS) and/or a satellite radio satellite and the first satellite frequency band is a DBS and/or satellite radio frequency band, and wherein the second satellite is a Mobile Satellite System (MSS) satellite and the second frequency band is an MSS frequency band.

3. A mobile terminal according to claim 1 wherein the mobile terminal transceiver system comprises:
a mobile terminal receiver that is configured to receive the audio, video and/or data content from the first satellite over the first satellite frequency band; and
a mobile terminal bidirectional transceiver that is configured to bidirectionally communicate with the second satellite and/or the ancillary terrestrial network over the second satellite frequency band to control the receiving of the audio, video and/or data content from the first satellite over the first satellite frequency band.

4. A mobile terminal according to claim 3 wherein the mobile terminal receiver and the mobile terminal bidirectional transceiver are at least partially integrated in the mobile terminal.

5. A mobile terminal according to claim 1 further comprising a mobile terminal controller that is configured to request the audio, video and/or data content from a content provider over the second satellite frequency band via the mobile terminal transceiver system, to obtain an authorization for the audio, video and/or data content from the content provider over the second satellite frequency band via the mobile terminal transceiver system and to limit the audio, video and/or data content from being received and/or used at the mobile terminal absent the authorization.

6. A mobile terminal according to claim 5 wherein the mobile terminal controller is further configured to preferentially request the audio, video and/or data content from the content provider via a set top box when the mobile terminal is proximate thereto, and to preferentially obtain the authorization for the audio, video and/or data content from the content provider via the set top box when the mobile terminal is proximate thereto.

7. A mobile terminal according to claim 6 wherein the mobile terminal controller is further configured to preferentially receive the audio, video and/or data content from the content provider via the set top box when the mobile terminal is proximate thereto.

8. A mobile terminal according to claim 5 wherein the mobile terminal controller is further configured to preferentially request the audio, video and/or data content from the content provider via a relay device that communicates with a set top box when the mobile terminal is proximate to the relay device, and to obtain the authorization for the audio, video and/or data content from the content provider via the relay device when the mobile terminal is proximate thereto.

9. A mobile terminal according to claim 8 wherein the mobile terminal controller is further configured to preferentially receive the audio, video and/or data content from the content provider via the relay device that communicates with the set top box when the mobile terminal is proximate to the relay device.

10. A mobile terminal according to claim 6 wherein the mobile terminal controller is further configured to transmit remote control commands to the set top box when the mobile terminal is proximate thereto.

11. A mobile terminal according to claim 8 wherein the mobile terminal controller is further configured to transmit remote control commands to the set top box via the relay device when the mobile terminal is proximate to the relay device.

12. A mobile terminal comprising:
a mobile terminal transceiver system that is configured to communicate with a first satellite over a first satellite frequency band and to communicate with a second satellite and an ancillary terrestrial network over a second satellite frequency band.

13. A mobile terminal according to claim 12 wherein the first satellite is a Direct Broadcast Satellite (DBS) and/or a satellite radio satellite and the first satellite frequency band is a DBS and/or satellite radio frequency band and wherein the second satellite is a Mobile Satellite System (MSS) satellite and the second frequency band is an MSS frequency band.

14. A mobile terminal according to claim 12 wherein the mobile terminal transceiver system is further configured to communicate with a set top box when the mobile terminal is proximate thereto.

15. A mobile terminal according to claim 12 wherein the mobile terminal transceiver system is further configured to communicate with a relay device that communicates with a set top box when the mobile terminal is proximate to the relay device.

16. A mobile terminal comprising:
a mobile terminal transceiver system that is configured to communicate wirelessly using a terrestrial and/or satellite frequency band and to communicate with a set top box when the mobile terminal is proximate thereto.

17. A mobile terminal according to claim 16 wherein the mobile terminal transceiver system is further configured to communicate with a relay device that communicates with the set top box when the mobile terminal is proximate to the relay device.

18. A set top box comprising:
a set top box transceiver system that is configured to receive audio, video and/or data content from a first satellite over a first satellite frequency band and/or via a wired connection and to communicate with a relay device that is external to the set top box that itself communicates with a second satellite and/or an ancillary terrestrial network over a second satellite frequency band, to control the receiving of the audio, video and/or data content.

19. A set top box according to claim 18 wherein the first satellite is a Direct Broadcast Satellite (DBS) and/or a satellite radio satellite and the first satellite frequency band is a DBS and/or satellite radio frequency band and wherein the second satellite is a Mobile Satellite System (MSS) satellite and the second frequency band is an MSS frequency band.

20. A set top box according to claim 18 wherein the set top box transceiver system comprises:
a set top box receiver that is configured to receive the audio, video and/or data content from the first satellite over the first satellite frequency band and/or via the wired connection; and
a set top box bidirectional transceiver that is configured to bidirectionally communicate with the second satellite and/or the ancillary terrestrial network over the second satellite frequency band via the relay device to control the receiving of the audio, video and/or data content from the first satellite over the first satellite frequency band and/or via the wired connection.

21. A set top box according to claim 20 wherein the set top box receiver and the set top box bidirectional transceiver are at least partially integrated.

22. A set top box according to claim 18 further comprising a set top box controller that is configured to request the audio, video and/or data content from a content provider over the second satellite frequency band via the set top box transceiver system and the relay device, to obtain an authorization for the audio, video and/or data content from the content provider over the first and/or second satellite frequency band via the set top box transceiver system and the relay device and to limit the audio, video and/or data content from being received and/or used at the set top box absent the authorization.

23. A set top box according to claim 22 wherein the set top box controller is further configured to request the audio, video and/or data content from the content provider in response to a request from a mobile terminal that is proximate the relay device and/or the set top box, and to provide the audio, video and/or data content to the mobile terminal via the relay device and/or the set top box.

24. A set top box according to claim 22 wherein the set top box controller is further configured to receive remote control commands for the set top box via the relay device.

25. A set top box relay device comprising:
a set top box relay device transceiver system that is external to a set top box and is configured to communicate with the set top box over a wireless and/or a wired connection and to communicate with a Mobile Satellite System (MSS) satellite and/or an ancillary terrestrial network over an MSS frequency band.

26. A set top box relay device according to claim 25 wherein the set top box relay device transceiver system is further configured to wirelessly communicate with a mobile terminal that is proximate thereto.

27. A set top box relay device according to claim 25 wherein the set top box relay device transceiver system is further configured to wirelessly communicate with a remote control unit that is proximate thereto.

28. A content providing system that provides audio, video and/or data content to a mobile terminal comprising:
a first satellite that is configured to transmit the audio, video and/or data content to the mobile terminal over a first satellite frequency band; and
a second satellite and/or an ancillary terrestrial network that is/are configured to communicate with the mobile terminal over a second satellite frequency band to control the receiving of the audio, video and/or data content from the first satellite over the first satellite frequency band.

29. A content providing system according to claim 28 wherein the first satellite is a Direct Broadcast Satellite (DBS) and/or a satellite radio satellite and the first satellite frequency band is a DBS and/or satellite radio frequency band, and wherein the second satellite is a Mobile Satellite System (MSS) satellite and the second frequency band is an MSS frequency band.

30. A content providing system according to claim 28 further comprising a content providing system controller that is configured to receive a request for the audio, video and/or data content from the mobile terminal over the second satellite frequency band via the second satellite and/or the ancillary terrestrial network and to provide an authorization for the audio, video and/or data content to the mobile terminal over the second satellite frequency band via the second satellite and/or the ancillary terrestrial network.

31. A content providing system according to claim 28 further comprising a content providing system controller that is configured to receive a request for the audio, video and/or data content from the mobile terminal over the second satellite frequency band via the second satellite and/or the ancillary terrestrial network and to refrain from providing the audio, video and/or data content to the mobile terminal over the first satellite frequency band via the first satellite if the request is unauthorized.

32. A content providing system according to claim 28 further comprising a content providing system controller that is configured to receive a request for the audio, video and/or data content from the mobile terminal via a set top box that is proximate thereto and the second satellite and/or the ancillary terrestrial network, and to provide an authorization for the audio, video and/or data content to the mobile terminal via the set top box and the second satellite and/or the ancillary terrestrial network.

33. A content providing system according to claim 28 further comprising a content providing system controller that is configured to receive a request for the audio, video and/or data content from the mobile terminal via a set top box that is proximate thereto and the second satellite and/or the ancillary terrestrial network and to refrain from providing the audio, video and/or data content to the mobile terminal via the set top box and the second satellite and/or the ancillary terrestrial network if the request is unauthorized.

34. A content providing system according to claim 28 further comprising a content providing system controller that is configured to receive a request for the audio, video and/or data content from the mobile terminal via a set top box and a relay device that are proximate thereto and the second satellite and/or the ancillary terrestrial network, and to provide an authorization for the audio, video and/or data content to the mobile terminal via the set top box and the relay device and the second satellite and/or the ancillary terrestrial network.

35. A content providing system according to claim 28 further comprising a content providing system controller that is configured to receive a request for the audio, video and/or data content from the mobile terminal via a set top box and a relay device that are proximate thereto and the second satellite and/or the ancillary terrestrial network, and to refrain from providing the audio, video and/or data content to the mobile terminal via the set top box and the relay device and the second satellite and/or the ancillary terrestrial network if the request is unauthorized.

36. A mobile terminal communications system comprising:
a first satellite that is configured to communicate with a mobile terminal over a first satellite frequency band; and
a second satellite and an ancillary terrestrial network that are configured to communicate with the mobile terminal over a second satellite frequency band.

37. A mobile terminal communications system according to claim 36 wherein the first satellite is a Direct Broadcast Satellite (DBS) and/or a satellite radio satellite and the first satellite frequency band is a DBS and/or satellite radio frequency band and wherein the second satellite is a Mobile Satellite System (MSS) satellite and the second frequency band is an MSS frequency band.

38. A mobile terminal communications system according to claim 36 wherein the second satellite and/or the ancillary terrestrial network is/are configured to communicate with the mobile terminal via a set top box when the mobile terminal is proximate thereto.

39. A mobile terminal communications system according to claim 36 wherein the second satellite and/or an ancillary terrestrial network is/are configured to communicate with the mobile terminal via a relay device that communicates with the set top box when the mobile terminal is proximate to the relay device.

40. A content providing system that provides audio, video and/or data content to a set top box comprising:
a content transmitting system that is configured to transmit the audio, video and/or data content to the set top box from a first satellite over a first satellite frequency band and/or via a wired connection; and
a content controlling system that is configured to communicate with a relay device that is external to the set top box, via a second satellite and/or an ancillary terrestrial network over a second satellite frequency band, to control the audio, video and/or data content at the set top box.

41. A content providing system according to claim 40 wherein the first satellite is a Direct Broadcast Satellite (DBS) and/or a satellite radio satellite and the first satellite frequency band is a DBS and/or satellite radio frequency band and wherein the second satellite is a Mobile Satellite System (MSS) satellite and the second frequency band is an MSS frequency band.

42. A content providing system according to claim 40 wherein the content controlling system is responsive to a request for the audio, video and/or data content from the set top box via the relay device and is configured to transmit an authorization for the audio, video and/or data content to the set top box via the relay device.

43. A content providing system according to claim 40 wherein the content controlling system is responsive to a request for the audio, video and/or data content from the set top box via the relay device and to limit the audio, video and/or data content from being transmitted and/or used at the set top box absent the authorization.

44. A mobile terminal communications method comprising:
receiving audio, video and/or data content at the mobile terminal from a first satellite over a first satellite frequency band; and
communicating between the mobile terminal and a second satellite and/or an ancillary terrestrial network over a second satellite frequency band to control the receiving of the audio, video and/or data content at the mobile terminal from the first satellite over the first satellite frequency band.

45. A method according to claim 44 wherein the first satellite is a Direct Broadcast Satellite (DBS) and/or a satellite radio satellite and the first satellite frequency band is a DBS and/or satellite radio frequency band, and wherein the second satellite is a Mobile Satellite System (MSS) satellite and the second frequency band is an MSS frequency band.

46. A method according to claim 44 further comprising:
preferentially receiving the audio, video and/or data content from the first satellite at the mobile terminal via a set top box when the mobile terminal is proximate thereto; and
preferentially communicating between the mobile terminal and the second satellite and/or the ancillary terrestrial network via the set top box when the mobile terminal is proximate thereto.

47. A method according to claim 44 further comprising:
preferentially receiving the audio, video and/or data content from the first satellite at the mobile terminal via a relay device that communicates with a set top box when the mobile terminal is proximate to the relay device; and
preferentially communicating between the mobile terminal and the second satellite and/or the ancillary terrestrial network via the relay device when the mobile terminal is proximate thereto.

48. A method according to claim 46 further comprising:
transmitting remote control commands from the mobile terminal to the set top box when the mobile terminal is proximate thereto.

49. A method according to claim 47 further comprising:
transmitting remote control commands form the mobile terminal to the set top box via the relay device when the mobile terminal is proximate to the relay device.

50. A mobile terminal communications method comprising:
communicating between a mobile terminal and a first satellite over a first satellite frequency band; and
communicating between the mobile terminal and a second satellite and/or an ancillary terrestrial network over a second satellite frequency band.

51. A method according to claim 50 wherein the first satellite is a Direct Broadcast Satellite (DBS) and/or a satellite radio satellite and the first satellite frequency band is a DBS and/or satellite radio frequency band and wherein the second satellite is a Mobile Satellite System (MSS) satellite and the second frequency band is an MSS frequency band.

52. A method according to claim 50 further comprising:
communicating between the mobile terminal and a set top box when the mobile terminal is proximate thereto.

53. A method according to claim 50 further comprising:
communicating between the mobile terminal and a relay device that communicates with a set top box when the mobile terminal is proximate to the relay device.

54. A mobile terminal communications method comprising:
communicating wirelessly by the mobile terminal using a terrestrial and/or satellite frequency band; and
communicating between the mobile terminal and a set top box when the mobile terminal is proximate thereto.

55. A method according to claim 54 further comprising:
communicating between the mobile terminal and a relay device that communicates with the set top box when the mobile terminal is proximate to the relay device.

56. A set top box communication method comprising:
receiving audio, video and/or data content at a set top box from a first satellite over a first satellite frequency band and/or via a wired connection; and
communicating between the set top box and a relay device that is external to the set top box that itself communicates with a second satellite and/or an ancillary terrestrial network over a second satellite frequency band, to control the receiving of the audio, video and/or data content.

57. A method according to claim 56 wherein the first satellite is a Direct Broadcast Satellite (DBS) and/or a satellite radio satellite and the first satellite frequency band is a DBS and/or satellite radio frequency band and wherein the second satellite is a Mobile Satellite System (MSS) satellite and the second frequency band is an MSS frequency band.

58. A method according to claim 56 further comprising:
receiving remote control commands at the set top box via the relay device.

59. A set top box relay device communications method comprising:
communicating between the relay device and a set top box over a wireless and/or a wired connection; and
communicating between a relay device and a Mobile Satellite System (MSS) satellite and/or an ancillary terrestrial network over an MSS frequency band.

60. A method according to claim 59 further comprising:
wirelessly communicating between the relay device and a mobile terminal that is proximate to the relay device.

61. A method according to claim 59 further comprising:
wirelessly communicating between the relay device and a remote control unit that is proximate to the relay device.
